(19) United States
(12) Patent Application Publication
(10) Pub. No.: US 2012/0250015 A1
(43) Pub. Date: Oct. 4, 2012

(54) High-Resolution Spectral Volume Sampling

(75) Inventor: Alan B. Marchant, Hyrum, UT (US)

(73) Assignee: Utah State University Research Foundation, North Logan, UT (US)

(21) Appl. No.: 13/431,794

(22) Filed: Mar. 27, 2012

Related U.S. Application Data
(60) Provisional application No. 61/468,352, filed on Mar. 28, 2011.

(51) Int. Cl. G01J 3/42

(52) U.S. Cl. 356/320

(57) ABSTRACT

For high-resolution spectral volume sampling, a band-pass filter spectrally filters electromagnetic radiation from a scene to wavelengths within a specified wavelength range. A slit array is located at an image of the scene and includes a plurality of slits arranged in parallel. Each slit has a specified width and a specified spacing between slits. Each slit further transmits the electromagnetic radiation. A dispersion device disperses the transmitted electromagnetic radiation from the slit array with a specified dispersion while focusing the transmitted electromagnetic radiation onto a detector array so that each wavelength of electromagnetic radiation from each slit is focused as a unique, non-overlapping line on the detector array.

### CROSS-REFERENCE TO RELATED APPLICATIONS

This application claims priority to U.S. Provisional Patent Application No. 61/468,352 entitled “OXYGEN LIMB PHOTOMETER APPARATUS AND METHOD” and filed on Mar. 28, 2011 for Alan Marchant, which is incorporated herein by reference.

### FIELD

The subject matter disclosed herein relates to volume sampling and more particularly relates to high-resolution spectral volume sampling.

### BACKGROUND

### Description of the Related Art

Instruments such as photometers may measure selected spectra to determine concentrations of a molecule or element or source physical characteristic such as temperature or pressure. The measurements may be taken at multiple angles.

### BRIEF SUMMARY

An apparatus for high-resolution spectral volume sampling is disclosed. A band-pass filter spectrally filters electromagnetic radiation from a scene to wavelengths within a specified wavelength range. A slit array is located at an image of the scene and includes a plurality of slits arranged in parallel. Each slit has a specified width and a specified spacing between slits. Each slit further transmits the electromagnetic radiation. A dispersion device disperses the transmitted electromagnetic radiation from the slit array with a specified dispersion while focusing the transmitted electromagnetic radiation onto a detector array so that each wavelength of electromagnetic radiation from each slit is focused as a unique, non-overlapping line on the detector array. A method and system for performing functions of the apparatus are also disclosed.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a high-resolution spectral volume sampling apparatus;

FIG. 2 is a schematic block diagram illustrating one alternate embodiment of a high-resolution spectral volume sampling apparatus;

FIG. 3 is a schematic block diagram illustrating one embodiment of a high-resolution spectral volume sampling system;

FIG. 4 is a front view drawing illustrating one embodiment of a slit array;

FIG. 5 is a top view drawing illustrating one embodiment of the detector array;

FIG. 6 is a schematic drawing illustrating one embodiment of lines of electromagnetic radiation on a detector array;

FIG. 7 is a graph 400 showing A-Band limb radiance for molecular oxygen; and

FIG. 8 is a schematic flow chart diagram illustrating one embodiment of a high-resolution spectral volume sampling method.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

The schematic flowchart diagrams and/or schematic block diagrams in the Figures illustrate the architecture, functionality, and operation of possible implementations. It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Although various arrow types and line types may be employed in the flowchart and/or block diagrams, they are understood not to limit the scope of the corresponding embodiments. Indeed, some arrows or other connectors may be used to indicate only an exemplary logical flow of the depicted embodiment.

The description of elements in each figure may refer to elements of proceeding figures. Like numbers refer to like elements in all figures, including alternate embodiments of like elements.

Embodiments are presented for high-resolution spectral volume sampling. The embodiments may be employed for measuring limb radiation or simultaneously imaging high and low intensity portions of a scene. Limb radiation measurements may be taken of a volume of atmosphere, a volume of a stellar object, or the like.

In a certain embodiment, measurements of limb radiation may be used to determine thermosphere temperatures. For example, measuring limb radiation may be used to measure temperatures at various altitudes within an atmospheric volume from a spectral structure. Such a measurement may include continuous sampling at a high spectral and spatial resolution from a high-intensity portion of a scene to a low-intensity portion of a scene. In addition, measurements may be taken at angles orthogonal to a high-intensity/low-intensity axis.

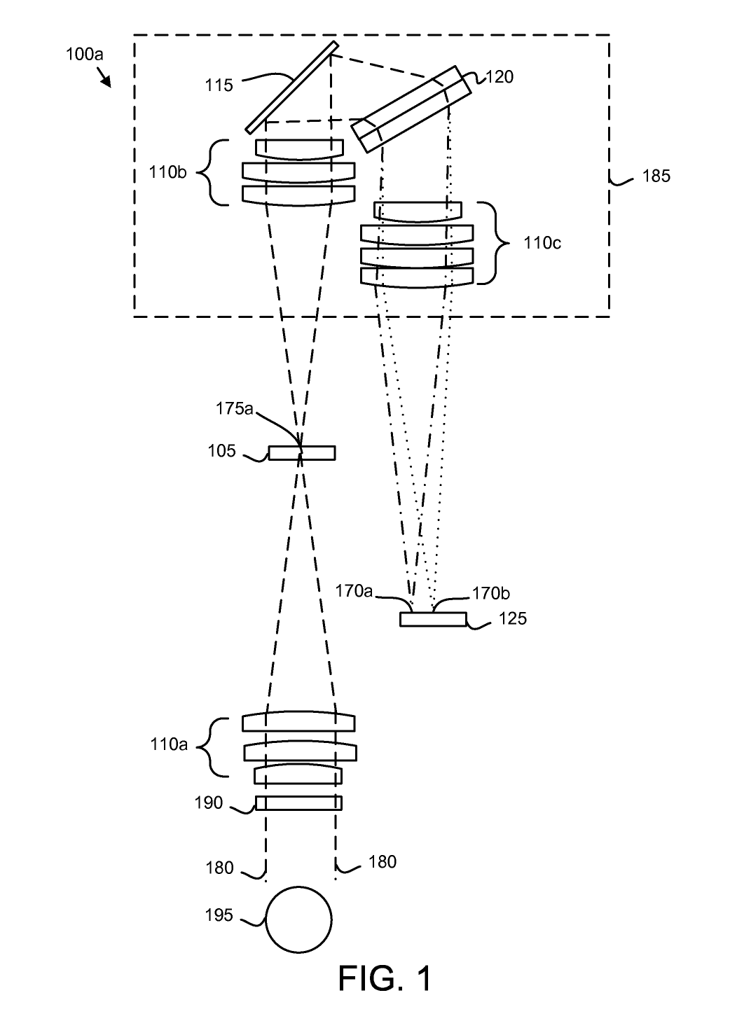

FIG. 1 is a schematic block diagram illustrating one embodiment of a high-resolution spectral volume sampling apparatus 100a. In the depicted embodiment, the apparatus 100a includes a band-pass filter 190, a slit array 105, one or more lens assembly 110, a mirror 115, a dispersion element 120, a dispersion device 185, and a detector array 125. One of skill in the art will recognize that embodiments may be practiced with any number of band-pass filters 190, slit arrays 105, lens assembly 110, mirrors 115, dispersion elements 120, dispersion devices 185, and detector arrays 125.

The band-pass filter 190 receives electromagnetic radiation 180 from a scene 195. For simplicity, the scene 195 is schematically rendered as a circle. However, the scene 195 may be a volume such as an atmospheric limb volume, a coronal limb volume, or the like.

The band-pass filter 190 spectrally filters the electromagnetic radiation 180 to wavelengths within a specified wavelength range. For example, the band-pass filter 190 may filter the electromagnetic radiation to a range of 760-768 nanometers (nm). The specified wavelength range may be the molecular oxygen A-band. Table 1 illustrates other embodiments of specified wavelength ranges. The specified wavelength range may comprise one or more wavelength intervals, each with a lower and an upper bound.

TABLE 1

| | Wavelength Lower | |
|---|---|---|
| | Bound | Wavelength Upper Bound |
| Oxygen A Band | 760 nm | 768 nm |
| Sodium D Line | 588 nm | 591 nm |
| 940 nm H₂O Band | 880 nm | 990 nm |

Each lens assembly 110 may include one or more lenses. Each lens assembly 110 may also be an optical device. A first lens assembly 110a may focus the electromagnetic radiation 180 at a first image 175a. The slit array 105 may be disposed at the first image 175a. The slit array 105 may include a plurality of slits arranged in parallel as will be illustrated in more detail hereafter. Each slit may have a specified width and the specified spacing between the slits. Each slit transmits the spectrally filtered electromagnetic radiation 180. In one embodiment, there is no overlap between the transmitted electromagnetic radiation 180 from each slit.

In the depicted embodiment, the second lens assembly 110b and the mirror 115 concentrate the transmitted electromagnetic radiation 180 onto the dispersion element 120. The dispersion element 120 and the second lens assembly 110b may be embodied in the dispersion device 185. The dispersion element 120 may include one or more elements selected from the group consisting of a volume holographic diffraction grating, a ruled diffraction grating, an e-beam fabricated grating, a replica grating, and a prism. The dispersion element 120 is depicted as a volume holographic diffraction grating.

The dispersion device 185 reimages the transmitted electromagnetic radiation 180 from the slit array 105 onto the detector array 125. In one embodiment, the dispersion device 185 reimages the electromagnetic radiation 180 with a reimaging magnification. In the depicted embodiment, a third lens assembly 110c focuses the electromagnetic radiation 180 onto the detector array 125. The third lens assembly 110c may be embodied in the dispersion device 185. The dispersion element 120 further disperses the transmitted electromagnetic radiation 180 with the specified dispersion so that each wavelength of electromagnetic radiation 180 from each slit is focused is a unique, non-overlapping line on the detector array 125.

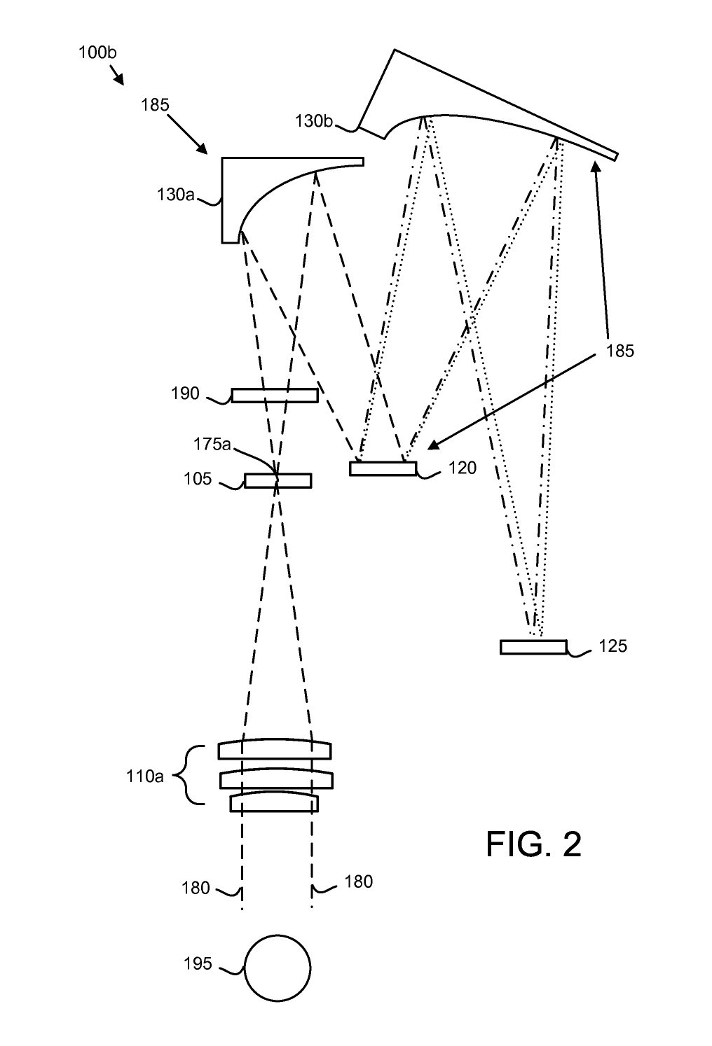

FIG. 2 is a schematic block diagram illustrating one alternate embodiment of a high-resolution spectral volume sampling apparatus 100b. The apparatus 100b includes the band-pass filter 190, the one or more lens assemblies 110, the slit array 105, the dispersion element 120, and the detector array 125 of FIG. 1. In addition, the apparatus 100b includes one or more curved mirrors 130. The curved mirrors 130 may each be an optical device.

Each slit of the slit array 105 transmits electromagnetic radiation from the scene 195. The band-pass filter 190 spectrally filters the electromagnetic radiation 180 from the slit array 105 to wavelengths within the specified wavelength range. The band pass filter 190 may filter the electromagnetic radiation anywhere in the electromagnetic radiation's path between the scene 195 and the detector array 125. In a certain embodiment, the specified wavelength range is 759 to 769 nm. In one embodiment, the first lens assembly 110a focuses the electromagnetic radiation 180 on the slit array 105 at the first image 175a.

A first curved mirror 130a concentrates the electromagnetic radiation from the slit array 105 onto the dispersion element 120. The dispersion device 185 reimages the electromagnetic radiation 180 from the slit array 105 onto the detector array 125. In the depicted embodiment, the second curved mirror 130b contributes to focusing the electromagnetic radiation 180 on to the detector array 125. The dispersion element 120 may disperse the transmitted electromagnetic radiation 180 with the specified dispersion so that each wavelength of the electromagnetic radiation from each slit is focused as a unique, non-overlapping line on the detector array 125.

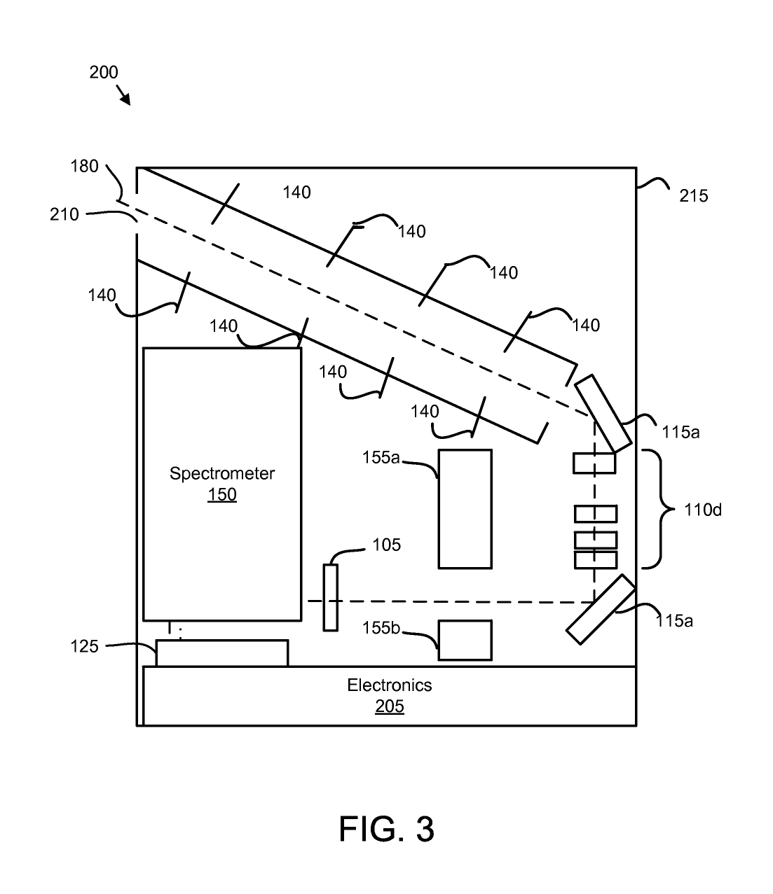

FIG. 3 is a schematic block diagram illustrating one embodiment of an exemplary high-resolution spectral volume sampling system 200. The exemplary system 200 may include the apparatus 100 of FIG. 1 or 2. The exemplary system 200 further includes a case 215, an aperture 210, one or more baffles 140, one or more mirrors 115, at least one lens assembly 110, a shutter 155, a imaging spectrometer 150, electronics 205, the slit array 105, and the detector array 125.

The electromagnetic radiation 180 may enter the system 200 through the aperture 210. The aperture 210 and associated collection optics may have a field of view in the range of 14 to 261 milliradians (mrad). In a certain embodiment, the vertical field of view is in the range of 14-52 mrad, wherein vertical is along a limb axis. In addition, a horizontal field of view may be in the range of 166-209 mrad. Alternatively, in a terrestrial setting, the dimensions of the field of view may be quite different.

The baffles 140 may block electromagnetic radiation 180 that is outside of the field of view. The mirrors 115 and a fourth lens assembly 110d may concentrate the electromagnetic radiation on the slit array 105. The fourth lens assembly 110d may be configured as the collection optics. Alternatively, a telescope may focus the electromagnetic radiation 180 from the scene 190 on the slit array 105. In one embodiment, the shutter 155 may block the electromagnetic radiation 180 from falling on the slit array 105, for example, during calibration.

The spectrometer 150 may include the dispersion device 185 and one or more optical devices as described in FIGS. 1 and 2. The dispersion device 185 of the spectrometer 150 may reimage the electromagnetic radiation 180 from the slit array 105 onto the detector array 125. The electronics 205 may determine the intensity along each line of electromagnetic radiation 180 that is focused on the detector array 125.

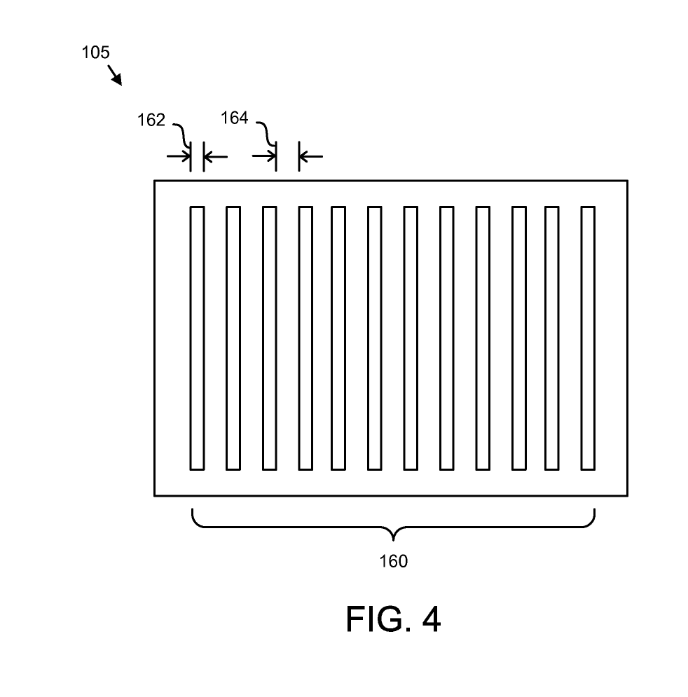

FIG. 4 is a front view drawing illustrating one embodiment of a slit array 105. The slit array 105 is the slit array 105 of FIGS. 1-3. The slit array 105 includes a plurality of slits 160. Each slit 160 has a specified width 162 and a specified spacing 164 between slits 160. In one embodiment, the specified width 162 is in the range of 1-25% of the specified spacing 164. The specified width 162 may be in the range of 10 to 100 micrometers (μm). In a certain embodiment, the specified width 162 is in the range of 30 to 50 μm.

In a certain embodiment, the reimaging magnification m of the dispersion device 185 is greater than the specified wavelength range r multiplied by the specified dispersion d and divided by the specified spacing s 164. Thus a lower bound for the specified spacing s 164 may be calculated using Equation 1 from the reimaging magnification m, the specified wavelength range r, and the specified dispersion d.

s>rd/m Equation 1

In one embodiment, the number of slits 160 is in the range of 4 to 30 slits 160. In a certain embodiment, nine slits 160 are employed. Alternatively, 11 slits 160 may be employed. The slits 160 may be formed as apertures in a chrome mask.

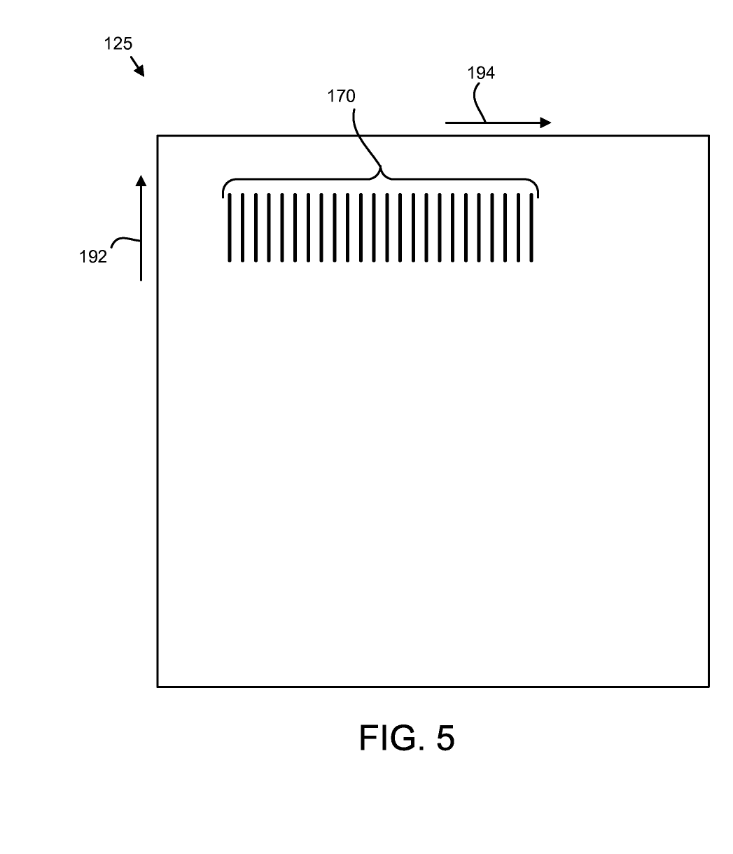

FIG. 5 is a top view drawing illustrating one embodiment of the detector array 125. The detector array 125 is the detector array 125 of FIGS. 1-3. The detector array 125 includes a first axis 192 and a second axis 194 that is orthogonal to the first axis 192. The first axis 192 may be the vertical axis. The wavelengths of the electromagnetic radiation 180 from each slit 160 may be focused as unique, non-overlapping lines 170 on the detector array 125. In one embodiment, each line 170 comprises a monochromatic image of a linear segment of the scene 195.

The detector array 125 may comprise a plurality of pixels. The electronics 205 may sample the pixels to determine an intensity of the electromagnetic radiation 180 focused on each pixel of each line 170. The sampling over the line 170 may provide intensities for a wavelength of the electromagnetic radiation 180 along the first axis 192. The sampling over the line 170 may provide intensities for a wavelength of the electromagnetic radiation over a limb field of view of the scene 195. In addition, the detector array 125 may discretely sample the electromagnetic radiation 180 at specified angles within the field of view of the scene 195 along the second axis 194. In one embodiment, the spatial resolution of each line 170 along the first axis 192 is in the range of 0.2-3 mrad. In addition, the spatial resolution of the lines 170 along the second axis 194 may be in the range of 20-50 mrad.

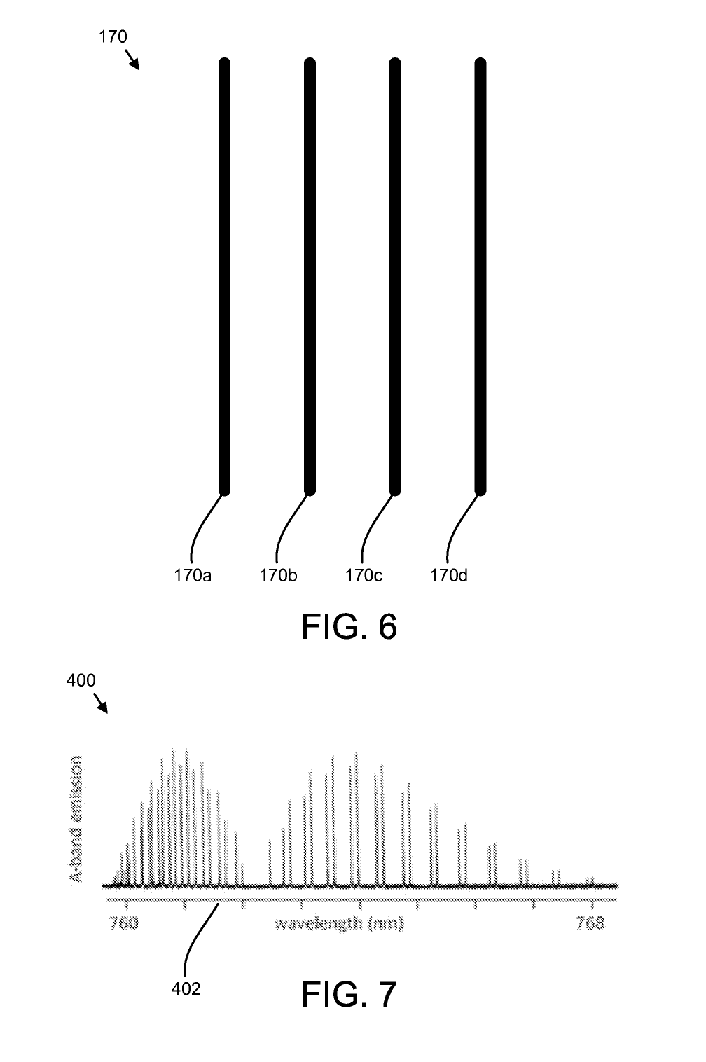

FIG. 6 is a schematic drawing illustrating one embodiment of lines 170 of electromagnetic radiation 180 on the detector array 125. The lines 170 are the lines 170 of FIG. 5. For simplicity, only four lines 170 are shown. In one embodiment, a first line 170a and a second line 170b comprise electromagnetic radiation 180 originating from the same slit 160. The first line 170a comprises a first wavelength of the electromagnetic radiation 180 and the second line 170b may comprise a second wavelength of electromagnetic radiation 180. Similarly a third line 170c and a fourth line 170d may originate from an adjacent slit 160, with the third line 170c comprising the first wavelength of the electromagnetic radiation 180 and the fourth line 170d comprising the second wavelength of the electromagnetic radiation 180. The first and second wavelengths may be emission wavelengths for a molecule such as oxygen.

FIG. 7 is a graph 400 showing A-Band limb radiance for molecular oxygen. The intensity of the electromagnetic radiation is shown vertically for various wavelengths 402. The first and second wavelengths of FIG. 6 may be centered on the 762 nm and 768 nm absorption wavelengths, illustrated by the graph 400.

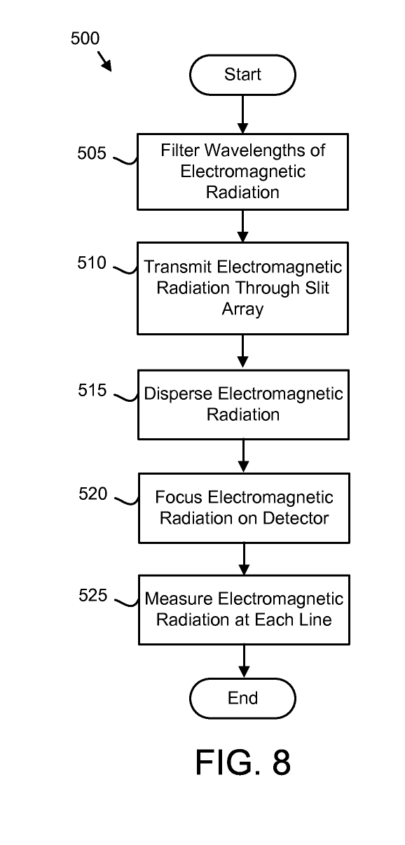

FIG. 8 is a schematic flow chart diagram illustrating one embodiment of a high-resolution spectral volume sampling method 500. The method 500 may perform the functions of the apparatus 100 and system 200 of FIGS. 1-6.

The method 500 starts, and the band-pass filter 190 spectrally filters 505 electromagnetic radiation 180 from the scene 195 to wavelengths within a specified wavelength range. The slit array 105 may be disposed at the first image 175a of the scene 195. The slit array 105 may include a plurality of slits 160 arranged in parallel, and each slit 160 may have the specified width 162 and the specified spacing 164 between the slits 160. Each slit 160 transmits 510 the spectrally filtered electromagnetic radiation 180.

The dispersion device 185 disperses 515 the transmitted electromagnetic radiation 180 from the slit array 105 with the specified dispersion. In one embodiment, the dispersion device 185 focuses 520 the electromagnetic radiation 180 with the reimaging magnification so that each wavelength of electromagnetic radiation 180 from each slit 160 is focused as a unique, non-overlapping line 170 on the detector array 125. The dispersion device 185 may comprise an optical device such as a lens assembly 110 and/or a curved mirror 130 that focuses 520 the electromagnetic radiation 180 onto the detector array 125.

In one embodiment, the detector array 125 measures 525 the intensity of the electromagnetic radiation at each line 170 and the method 500 ends. The spectral resolution may be in the range of 0.4-2 nm. Alternatively, the spectral resolution may be in the range of 0.5-0.6 nm.

The embodiments provide high-resolution spectral sampling with high-spatial resolution. In addition, the embodiments provide high spatial resolution with continuous spatial sampling along a first axis 192 that may be a limb axis and discrete sampling along a second axis 194. Thus a fixed apparatus 100 may provide dynamic hyperspectral imagery of a two-dimensional scene 195. In one embodiment, the intensities of the lines 170 are related to thermosphere temperature, providing accurate temperature measurements. Additionally, in one embodiment, the dynamic hyperspectral imagery collected from a moving sensor may be deconvolved to spatially characterize the source in three dimensions.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a band-pass filter spectrally filtering electromagnetic radiation from a scene to wavelengths within a specified wavelength range;
a slit array located at an image of the scene comprising a plurality of slits arranged in parallel, each slit having a specified width and a specified spacing between slits, each slit transmitting the electromagnetic radiation; and
a dispersion device dispersing the transmitted electromagnetic radiation from the slit array with a specified dispersion and focusing the transmitted electromagnetic radiation onto a detector array so that each wavelength of electromagnetic radiation from each slit is focused as a unique, non-overlapping line on the detector array.

2. The apparatus of claim 1, wherein each line comprises a monochromatic image of a linear segment of the scene.

3. The apparatus of claim 1, wherein a reimaging magnification is greater than the specified wavelength range multiplied by the specified dispersion and divided by the specified spacing between slits.

4. The apparatus of claim 1, wherein the dispersion device further comprises a first optical device concentrating the electromagnetic radiation from the slit array onto a dispersion element and a second optical device focusing the electromagnetic radiation onto the detector array.

5. The apparatus of claim 4, wherein the first optical device is a curved mirror.

6. The apparatus of claim 4, wherein the first optical device comprises at least one lens.

7. The apparatus of claim 4, wherein the second optical device is a curved mirror.

8. The apparatus of claim 4, wherein the second optical device comprises at least one lens.

9. The apparatus of claim 1, further comprising collection optics focusing the electromagnetic radiation from the scene onto the slit array.

10. The apparatus of claim 1, wherein the specified width is in the range of 1-25% of the specified spacing.

11. The apparatus of claim 1, wherein the dispersion device comprises one or more elements selected from the group consisting of a volume holographic diffraction grating, a ruled diffraction grating, an e-beam fabricated grating, a replica grating, and a prism.

12. A method for high-resolution spectral volume sampling comprising:
spectrally filtering electromagnetic radiation from a scene to wavelengths within a specified wavelength range;
transmitting the electromagnetic radiation through a slit array located at an image of the scene, the slit array comprising a plurality of slits arranged in parallel, each slit having a specified width and a specified spacing between slits;
dispersing the transmitted electromagnetic radiation from the slit array with a specified dispersion;
focusing the transmitted electromagnetic radiation onto a detector array so that each wavelength of electromagnetic radiation from each slit is focused as a unique, non-overlapping line on the detector array.

13. The method of claim 12, wherein each line comprises a monochromatic image of a linear segment of the scene.

14. The method of claim 12, wherein a reimaging magnification is greater than the specified wavelength range multiplied by the specified dispersion and divided by the specified spacing between slits.

15. The method of claim 12, wherein the specified width is in the range of 1-25% of the specified spacing.

16. The method of claim 12, wherein the dispersion device comprises one or more elements selected from the group consisting of a volume holographic diffraction grating, a ruled diffraction grating, an e-beam fabricated grating, a replica grating, and a prism.

17. A system comprising:
collection optics concentrating electromagnetic radiation from a scene at an image;
a band-pass filter spectrally filtering the electromagnetic radiation to wavelengths within a specified wavelength range;
a slit array located at the image comprising a plurality of slits arranged in parallel, each slit having a specified width and a specified spacing between slits, each slit transmitting the electromagnetic radiation; and
a dispersion device dispersing the transmitted electromagnetic radiation from the slit array with a specified dispersion and focusing the transmitted electromagnetic radiation onto a detector array so that each wavelength of electromagnetic radiation from each slit is focused as a unique, non-overlapping line on the detector array.

18. The system of claim 17, wherein the dispersion device further comprises a first optical device concentrating the electromagnetic radiation from the slit array onto a dispersion element and a second optical device focusing the electromagnetic radiation onto the detector array.

19. The system of claim 17, wherein the specified width is in the range of 1-25% of the specified spacing.

20. The system of claim 17, wherein the dispersion device comprises one or more elements selected from the group consisting of a volume holographic diffraction grating, a ruled diffraction grating, an e-beam fabricated grating, a replica grating, and a prism.
